(19) United States
(12) Patent Application Publication
(10) Pub. No.: US 2011/0007931 A1
(43) Pub. Date: Jan. 13, 2011

(54) SPEAKER DIAPHRAGM, SPEAKER, AND METHOD FOR MANUFACTURING SPEAKER DIAPHRAGM

(75) Inventors: Yohei Jin, Mie (JP); Kazuyoshi Mimura, Mie (JP); Shinya Mizone, Mie (JP); Toru Fujii, Kyoto (JP)

Correspondence Address: RATNERPRESTIA, P.O. BOX 980, VALLEY FORGE, PA, 19482, US

(73) Assignee: Panasonic Corporation

(21) Appl. No.: 12/921,231

(22) PCT Filed: Jul. 23, 2009
(86) PCT No.: PCT/JP2009/003453

§ 371 Date: Sep. 7, 2010

(30) Foreign Application Priority Data
Jul. 25, 2008 (JP) 2008-191948
Jul. 31, 2008 (JP) 2008-197325

(51) Int. Cl. H04R 1/00; G10K 13/00; D21F 13/00

(52) U.S. Cl. 381/398; 181/169; 162/218

(57) ABSTRACT

A speaker diaphragm of the present invention is molded by paper-making molding, using not smaller than 5 wt % of fibers extracted from at least bamboo leaves. It is thereby possible to improve the rigidity of the speaker diaphragm, so as to realize a speaker diaphragm with low environmental load, reducible cost and high sound quality.

### TECHNICAL FIELD

The present invention relates to a speaker diaphragm and a speaker for use in a variety of acoustic equipment or video equipment, a method for manufacturing the speaker diaphragm, electronic equipment such as a stereo set and a television set, and a mobile device such as an automobile.

### BACKGROUND ART

In the current audio industry and industry for automobiles mounted with audio equipment, an audio signal of high definition and broadband quality has been achieved with the penetration of digital equipment. This has led to significant improvement in quality of a signal outputted from a speaker into which an audio signal of high-quality digital equipment is inputted. The trends with regard to the speaker in these industries are to further seek higher sound quality, lighter weight and a more environmentally conscious style.

In seeking the higher sound quality, for realization of sound-quality requirements as users' needs, it is urgently necessary to develop a diaphragm as a constituent component of a speaker which accounts for a large proportion in determination of the sound quality. The development of the diaphragm has been advanced with a focus on a paper diaphragm due to its advantage of being capable of controlling the sound quality with higher accuracy.

As pulp being a material for use in the paper diaphragm, craft pulp obtained from conifers through a beating step is used, and this has led to the situation of accelerating the shortage of conifers. Hence it is becoming essential to use an environmentally friendly material for the future.

Further, since not having sufficient rigidity, the conventional paper diaphragm has difficulty in sufficiently reproducing, with its sound quality in the high-tone range, sound quality in the high-tone range of digital equipment. Moreover, since a large number of steps are required in manufacturing of the paper diaphragm, those steps account for a large proportion of manufacturing cost of the speaker. In particular, with falling-price trends of the digital equipment, the demand for reducing the manufacturing cost of the paper diaphragm has become stronger.

As document information of these prior arts, for example, Patent Documents 1 and 2 are known.

### PRIOR ART DOCUMENT

### Patent Document

[Patent Document 1] Unexamined Japanese Patent Publication No. 2007-221635

[Patent Document 2] Unexamined Japanese Patent Publication No. H06-303695

### DISCLOSURE OF THE INVENTION

A speaker diaphragm of the present invention is manufactured by a paper-making method, using not smaller than 5 wt % of fibers extracted from at least bamboo leaves.

With this configuration, the use of fibers (pulp), obtained by extracting a silicon dioxide compound in a plant which abounds in bamboo leaves including bamboo grasses, for a paper diaphragm can improve the rigidity of the paper diaphragm to realize improvement in sound pressure in the high-tone range of a speaker and expansion of a reproduction band, so as to realize favorable sound quality. Further, according to the present invention, a speaker paper diaphragm that is inexpensive and environmentally friendly can be provided.

Moreover, a method for manufacturing a speaker diaphragm in the present invention includes: a beating step for beating pulp; a mixing step for mixing a material containing cellulose of natural fibers such as bamboo fibers; a paper-making step for spreading the material in the shape of a diaphragm; and a drying step for drying the diaphragm, characterized in that in the mixing step, water-dispersible polyisocyanate is further mixed. The speaker diaphragm contains a cellulose component of natural fibers such as bamboo fibers, and an isocyanate component, and the cellulose component of the natural fibers is cross-linked by the isocyanate component, thereby allowing realization of a speaker diaphragm with high sound quality. Further, a step of impregnation with polyisocyanate after the paper-making step can be omitted, thereby to reduce manufacturing cost.

### BRIEF DESCRIPTION OF THE DRAWINGS

FIG. 1 is a sectional view of a speaker diaphragm in Embodiment 1 of the present invention;

FIG. 2 is a flowchart illustrating a method for manufacturing a speaker diaphragm in Embodiment 2 of the present invention;

FIG. 3 is a sectional view of a speaker in Embodiment 3 of the present invention;

FIG. 4 is an external view of audio electronic equipment in Embodiment 4 of the present invention; and

FIG. 5 is a sectional view of a mobile device in Embodiment 5 of the present invention.

### PREFERRED EMBODIMENTS FOR CARRYING OUT OF THE INVENTION

Embodiments of the present invention are described below with reference to the drawings.

### Embodiment 1

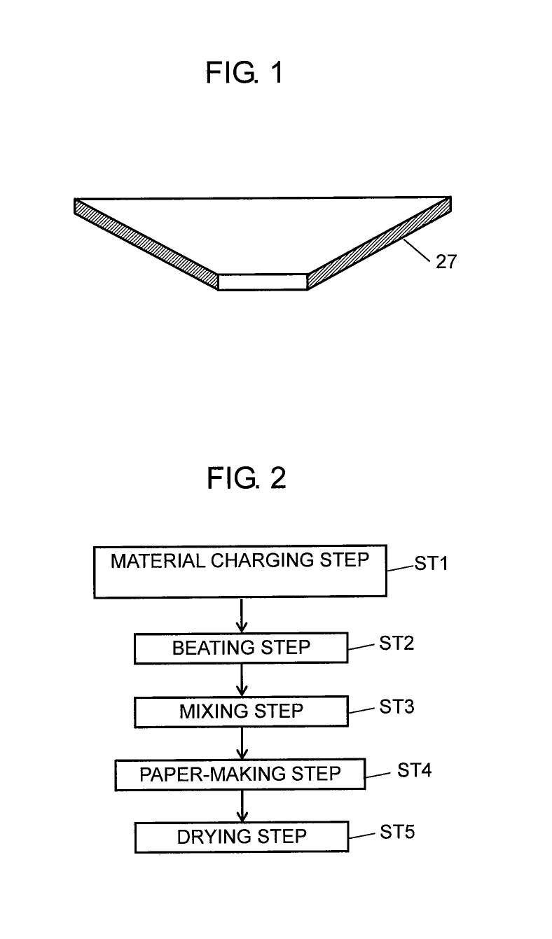

FIG. 1 is a sectional view of a speaker diaphragm in Embodiment 1 of the present invention. In FIG. 1, diaphragm 27 is a speaker diaphragm manufactured by a paper-making method, using not smaller than 5 wt % of fibers extracted from at least bamboo leaves. Natural fibers with high rigidity contain a large amount of a silicon dioxide compound. Further, since a shape and a size of the silicon dioxide compound vary depending upon a kind and a portion of a plant, the use of fibers (pulp) extracted from a kind and a portion of a plant containing a large amount of the silicon dioxide compound can improve the rigidity of the paper diaphragm, so as to improve the sound quality of the speaker diaphragm.

In other words, it is generally important to select natural fibers that are a material whose amount of the silicon dioxide compound in a plant, called plant opal, is taken into account.

In general, the silicon dioxide compound abounds most in a leaf portion in terms of a portion of a plant, and abounds most in a bamboo including bamboo grasses in terms of the kind of plant, and it is possible to obtain a large effect by using fibers (pulp) extracted from leaves of the bamboo for the paper diaphragm.

Further, from the viewpoint of the industrial stability, it is preferable to at least beat the fibers (pulp) extracted from bamboo leaves by a biaxial mixer. Although the biaxial mixer is not particularly limited so long as being capable of applying large shearing force to bamboo leaves, devices such as a two-roll device and a pressure kneader are effective in the respect of production efficiency.

The present invention is a speaker diaphragm formed by extracting fibers from bamboo leaves and using the fibers. It is possible to obtain a large effect when not smaller than 15 wt %, preferably not smaller than 30 wt %, of a fiber component of the bamboo leaves is used out of a total of fiber components of the speaker diaphragm and also when not smaller than 5 wt %, preferably not smaller than 10 wt %, of the fiber component is used in the case of the component having been made finer.

According to the need, a sizing agent, a paper strengthening agent, a waterproof agent, pigments, and the like may be used. Further, when 3 wt % to 10 wt % of raw rubber is used with respect to 100 wt % of fibers, a distortion property is improved.

Although examples of the present invention are described below, the examples by no means limit the present invention.

### Example 1

Bamboo leaves having a silicon concentration of 5030 μgSi/g and a weight of about 800 g are soaked into 400 g of water by chemical absorptiometry (molybdenum blue/yellow methods), and then processed by a pressure kneader with a volume of 3 L and 20 rpm at room temperature for ten minutes. A Canadian standard freeness of the bamboo fibers is 730 ml. From that pulp, a 16-cm circular speaker diaphragm is manufactured by a paper-making method. When measured in a 1-Hz tensile mode, a sound velocity determined from an elastic modulus at 20° C. is 2250 m/s.

There is generally a correlation between a sound velocity and a limit frequency of a high frequency, and for reproducing sound up to about 20 kHz as an audible frequency threshold for humans, a sound velocity of 1800 m/s is estimated to be practically required.

### Example 2

At a fiber ratio of 70 wt % of normal NUKP (wood craft pulp) and 30 wt % of the bamboo fibers of Example 1, a 16-cm circular speaker diaphragm is manufactured by the paper-making method as in Example 1. A sound velocity is 2100 m/s.

### Example 3

The bamboo fibers of Example 1 are processed by a bead mill, to be made finer up to a BET ratio surface area of 2 m²/g. A speaker diaphragm is manufactured in a similar manner to Example 1 except that 10 wt % of the fine bamboo fibers with a BET ratio surface area of 2 m²/g is mixed with respect to 90 wt % of the NUKP of Example 1. A sound velocity is 2400 m/s. Here, as a method for making the bamboo fibers finer, it is preferable to make the fibers finer by means of at least one kind or more of equipment of a bead mill, a pressure-type homogenizer, and a disk refiner.

### Example 4

A step of coating the speaker diaphragm of Example 1 by an aqueous solution with 0.1 wt % of the fine bamboo fibers of Example 3 and drying the diaphragm at 100° C. for 30 minutes is repeated until its weight increases by 0.5 g, to manufacture a speaker diaphragm. A sound velocity is 2450 m/s. Here, the method for coating with the bamboo fibers having been made finer is preferably surface coating by a spraying method or a suction/deposition paper-making method.

### Comparative Example 1

A speaker diaphragm is manufactured in a similar manner to Example 1 except that a fiber ratio is set to 100% of the NUKP of Example 2.In other words, it is a speaker diaphragm containing no bamboo fibers. A speed velocity is 1850 m/s.

### Example 5

The speaker diaphragms of five kinds, Examples 1 to 4 and Comparative Example 1, are incorporated into speakers with the magnets, frames and the like having the same specifications. Then, female vocals are listened to by ten speaker designers to make evaluations on a scale of one to five (one to two in Comparative Example 1) per designer, with focuses on force, stretch and power in the high-tone range.

Scores are: 33 marks in Example 1; 29 marks in Example 2; 38 marks in Example 3; 37 marks in Example 4; and 20 marks is Comparative Example 1.

The above results reveal that as the effect of the invention, in the speaker using the speaker diaphragm of the present invention, fibers extracted from bamboo leaves can improve the rigidity of the diaphragm, to realize improvement in voice pressure in the high-tone range and expansion of a reproduction band, so as to realize favorable sound quality. Further, with the use of a natural material that is fibers extracted from bamboo leaves, even the diaphragm is one having excellent sound quality in the high-tone range, a noisy feeling of sound is suppressed, and a natural and placid tone color can be provided.

### Embodiment 2

A speaker diaphragm of Embodiment 2 further contains an isocyanate component in addition to a cellulose component of the natural fibers such as the bamboo fibers. Cross-linking the cellulose component of the natural fibers such as the bamboo fibers by the isocyanate component can enhance the rigidity of the speaker diaphragm.

FIG. 2 is a flowchart illustrating a method for manufacturing the speaker diaphragm in Embodiment 2 of the present invention.

In a material charging step as Step 1 (ST1), pulp as a material for the speaker diaphragm is charged into a beater with water.

In a beating step as Step 2 (ST2), the pulp charged in the material charging step as Step 1 is minutely beaten over a several days.

In a mixing step as Step 3 (ST3), a sizing agent, a paper strength improvement agent and a stabilizer are mixed into the material beaten by the beating step as Step 2, and water-dispersible polyisocyanate is also mixed.

In a paper-making step as Step 4 (ST4), the material mixed by the mixing step as Step 3 is spread in a mold and on a metallic mesh arranged on the mold by a paper-making method, and sucked from the bottom to only discharge moisture, so as to be formed into a shape as the speaker diaphragm.

In a drying step as Step 5 (ST5), moisture contained in the speaker diaphragm formed by the paper-making step as Step 4 is evaporated by heating or pressurization.

The speaker diaphragm is completed by the above five steps.

It is to be noted that the above manufacturing method may be added with a punching step for punching, by means of a mold, the outermost periphery of the speaker diaphragm which becomes unnecessary as the speaker diaphragm and a central aperture section thereof into which a voice coil is inserted, the speaker diaphragm having been dried by the drying step as Step 5.

The method for manufacturing a speaker diaphragm, obtained by applying one embodiment in the present invention to the common conventional manufacturing method using the paper-making method, is described here, but the method for manufacturing a diaphragm which is applied is not limited to this, and any method is also applicable so long as including the mixing step.

Here, water-dispersible polyisocyanate for use in the mixing step as Step 3 is described. Water dispersible polyisocyanate is polyisocyanate with its water dispersibility improved by introducing a hydrophilic chain such as polyalkylene ether alcohol, and stabilized by introducing a moderate hydrophobic chain according to the need. An isocyanate group (NCO group) is protected by an interface chemical technique.

Examples of water-dispersible polyisocyanate may include: aromatic isocyanate such as 2,4-tolylene diisocyanate, 2,6-tolylene diisocyanate, 4,4′-diphenylmethane diisocyanate, 2,4′-diphenylmethane diisocyanate, 4,4′-diphenyl ether diisocyanate, 2-nitrodiphenyl-4,4′-diisocyanate, 2,2′-diphenylpropane-4,4′-diisocyanate, 3,3′-dimethyl diphenylmethane-4,4′-diisocyanate, 4,4′-diphenylpropane diisocyanate, m-phenylene diisocyanate, p-phenylene diisocyanate, naphthylene-1,4-diisocyanate, naphthylene-1,5-diisocyanate, and 3,3′-dimethoxydiphenyl-4,4′-diisocyanate, aliphatic isocyanate such as 1,6-hexamethylene diisocyanate, 1,4-tetramethylene diisocyanate, and lysine diisocyanate, araliphatic diisocyanate such as xylylene-1,4-diisocyanate and xylylene-1,3-diisocyanate, isophorone diisocyanate, hydrogenated tolylenediisocyanate, hydrogenated xylene diisocyanate, hydrogenated diphenylmethane diisocyanate, hydrogenated tetramethylxylylene diisocyanate, alicyclic diisocyanate, and an NCO-terminated compound obtained through a reaction between a compound of these and an active-hydrogen-group containing compound.

As water-dispersible polyisocyanate, in place of polyisocyanate obtained by adding polyol to organic isocyanate and also adding an isocyanurating catalyst to introduce an isocyanurate ring structure, a prepolymer-like isocyanate compound may be used which is obtained through a reaction between a polymer of diisocyanate, polyol with not less than two functional groups or the like and diisocyanate or a prepolymeric body.

In other words, both the polymeric body of polyisocyanate and polyol adduct of polyisocyanate can be used for the present invention. Alternatively, modified isocyanate obtained through a reaction of the above compounds, such as an uretdionizing reaction, a carbodiimidizing reaction, an urethane-imidizing reaction or a burette reaction, may be contained. Such polyisocyanate may be used alone or in a combination of two or more polyisocyanate. In the case of considering the stability of water dispersion, the stability of the NCO group after water dispersion, yellowing-free denaturation, and the like among such polyisocyanate, aliphatic or alicyclic polyisocyanate is preferred.

A specific example of methods for manufacturing a speaker diaphragm in the present invention is described below.

700 g of bamboo fibers, having an average fiber length of about 1.75 mm and configured of a bundle with a length of about 10 cm formed by unification of each fiber, are processed by a pressure kneader with a volume of 3 litters and 25 rpm at room temperature for 20 minutes, and then beaten. Subsequently, the beaten bamboo fibers are made a 5% water dispersion liquid, which is processed by a 3-litter bead mill using glass beads for 20 minutes, and further beaten. The fibers as thus beaten have an average fiber length of 0.8 mm, and a BET ratio surface area of 2.11 m²/g. Moreover, as water-dispersible polyisocyanate, for example, polyurethane-made Takenate WD-220, WB-700, or WB-920, manufactured by Mitsui Chemicals, Inc. is mixed into the water dispersion liquid. Subsequently, a water dispersion liquid containing the beaten bamboo fibers is spread, dried at 160° C. for five minutes, to complete a speaker diaphragm. This speaker diaphragm has a structure where the bamboo fibers as the cellulose component of natural fibers are cross-linked by water-dispersible polyisocyanate as the isocyanate component. It is thereby possible to increase the rigidity of the speaker diaphragm.

As thus described, by mixing water-dispersible polyisocyanate in the mixing step prior to the paper-making step, the diaphragm can be impregnated with polyol and polyisocyanate after the paper-making step, to make the rigidity of the diaphragm higher than in the case of covering the diaphragm with polyurethane. Further, since a step of impregnation with polyol and polyisocyanate after the paper-making step can be omitted, the manufacturing cost can be reduced. Moreover, as a result of listening evaluation of a speaker manufactured by Embodiment 2, especially sound in the high-tone range of a female soprano and the like can be made easier to listen to.

### Embodiment 3

An example of applying a speaker diaphragm of the present invention to a speaker is described below with reference to Embodiment 3.The speaker of Embodiment 3 is incorporated with the speaker diaphragm produced in Embodiment 1 or Embodiment 2.

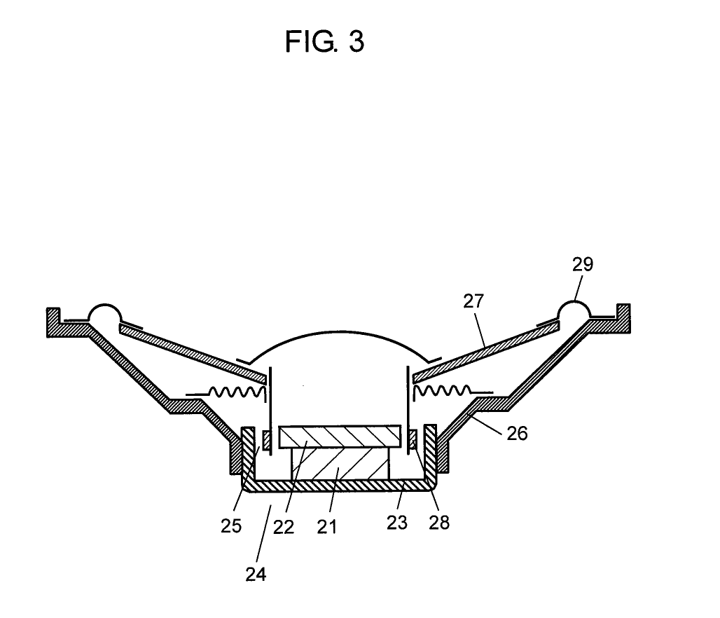

FIG. 3 is a sectional view of a speaker in Embodiment 3 of the present invention. Internal magnet-type magnetic circuit 24 is configured by sandwiching polarized magnet 21 between upper plate 22 and yoke 23. Frame 26 is coupled to yoke 23 of magnetic circuit 24. An outer periphery of speaker diaphragm 27 is attached to an outer peripheral portion of frame 26 by way of edge 29. One end of voice coil 28 is coupled to the central part of speaker diaphragm 27, while the other end of voice coil 28 is coupled so as to fit into magnetic gap 25 formed by magnetic circuit 24.

Although the speaker having internal magnet-type magnetic circuit 24 is described above, the present invention is not limited to this, and may be applied to a speaker having an external magnet-type magnetic circuit. Further, the present invention can also be applied to a small-sized speaker having diaphragm 27 and edge 29 united with each other.

The speaker using the speaker diaphragm of Embodiment 1 can improve the rigidity of the diaphragm by means of fibers extracted from bamboo leaves, to realize improvement in voice pressure in the high-tone range and expansion of the reproduction band, so as to realize favorable sound quality. Further, a noisy feeling of sound is suppressed, and a natural and placid tone color can be provided.

Moreover, it is possible to provide a speaker that is environmentally friendly, highly reliable and low cost, so as to realize a speaker excellent in the aspect of environment and cost as well as performance, quality and reliability.

As for the speaker using the speaker diaphragm of Embodiment 2,it is possible to realize a speaker with its rigidity reinforced by cross-linking the bamboo fibers as the cellulose component of the natural fibers by water-dispersible polyisocyanate as the isocyanate component. This speaker can reproduce deep bass having sharpness in the low-tone range and clear sound in the high-tone range.

### Embodiment 4

Audio electronic equipment having a speaker incorporated with the speaker diaphragm of the present invention is described below with reference to Embodiment 4.

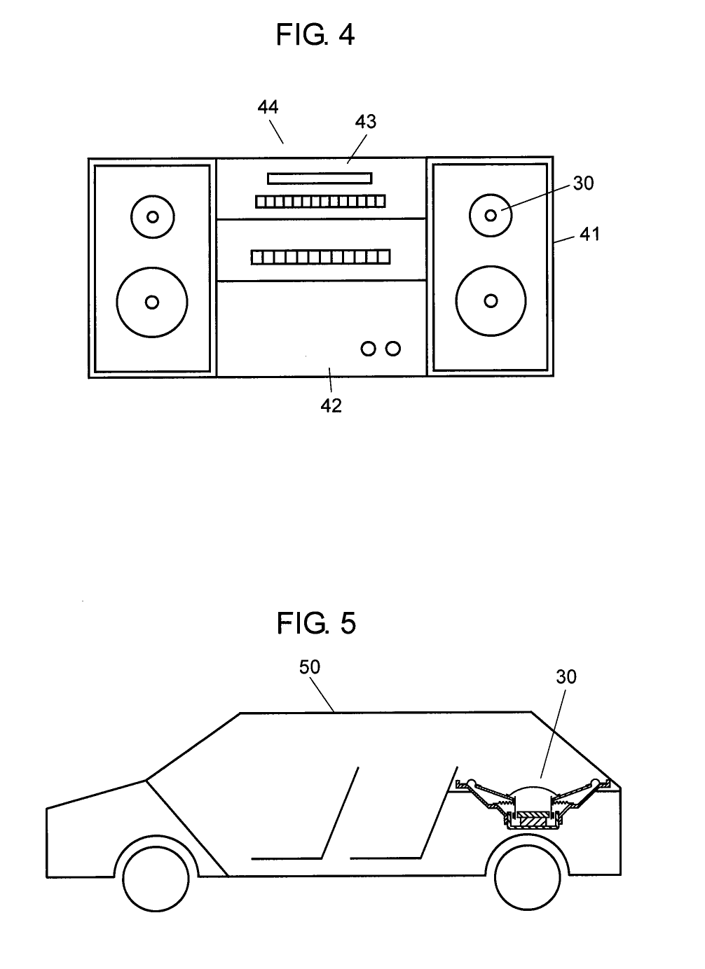

FIG. 4 is an external view of audio electronic equipment in Embodiment 4 of the present invention. Speaker 30 of Embodiment 4 is incorporated with the speaker diaphragm produced in Embodiment 1 or Embodiment 2. Speaker 30 is incorporated into enclosure 41, to constitute a speaker system. Amplifier 42 for amplifying an audio signal to be inputted into speaker 30 and player 43 for outputting an audio signal to be inputted into amplifier 42 are provided, to constitute audio electronic equipment 44.

With the above configuration, it is possible to realize low-cost audio electronic equipment 44 with high sound quality which realizes improvement in sound pressure in the high-tone range and expansion of the reproduction band. Further, it is possible to realize audio electronic equipment 44 that is environmentally friendly and inexpensive as well as being excellent in performance, quality and reliability.

It should be noted that, although floor-mounted audio electronic equipment 44 is described as an example in Embodiment 4, the present invention is not limited to this. The present invention is also applicable to portable audio equipment, game equipment and the like which can be carried. Further, the present invention is also applicable to video equipment, information equipment such as a cellular telephone, and the like.

### Embodiment 5

A mobile device having a speaker incorporated with the speaker diaphragm of the present invention is described below with reference to Embodiment 5.

FIG. 5 is a sectional view of a mobile device in Embodiment 5 of the present invention. As for the mobile device of FIG. 5, an automobile is used as a specific example. In FIG. 5, speaker 30 is incorporated with the speaker diaphragm produced in Embodiment 1 or Embodiment 2. In automobile 50, speaker 30 is incorporated into a rear tray or a front panel, and driven by an amplifier (not shown), to be used as part of vocal outputs of car navigation equipment and car audio equipment.

With this configuration, it is possible to realize automobile 50 provided with speaker 30 with high sound quality and its cost reduced, which realizes improvement in sound pressure in the high-tone range and expansion of the reproduction band. Further, it is possible to provide a mobile device that is inexpensive and environmentally friendly, to realize a mobile device excellent in the aspect of environment and cost as well as performance, quality and reliability.

It is to be noted that in Embodiment 5,automobile 50 is described as an example of the mobile device. The present invention is broadly applicable to mobile devices at least provided with a mobile means and incorporated with speaker 30, such as a bike as a two-wheel vehicle and the like and a train running on rails.

Further, although the speaker diaphragm of the present invention is described using the example of being formed by paper-making molding, it is not limited to this, and the formation can also be implemented by other methods such as injection-molding and press-molding.

### INDUSTRIAL APPLICABILITY

A speaker diaphragm, a speaker, electronic equipment and a mobile device of the present invention are applicable to a speaker, electronic equipment, video audio equipment and information communication equipment, and further to mobile devices such as an automobile, each of which requires a speaker having high sound quality, high reliability and low environmental load.

### REFERENCE MARKS IN THE DRAWINGS

21 Magnet
22 Upper plate
23 Yoke
24 Magnetic circuit
25 Magnetic gap
26 Frame
27 Speaker diaphragm
28 Voice coil
29 Edge
30 Speaker
41 Enclosure
42 Amplifier
43 Player
44 Audio electronic equipment
50 Automobile

1. A speaker diaphragm, which is manufactured by a paper-making method, wherein the diaphragm has not smaller than 5 wt % of fibers extracted from at least bamboo leaves.

2. The speaker diaphragm according to claim 1, wherein a concentration of silicon in the bamboo leaves is not lower than 5000 μgSi/g.

3. The speaker diaphragm according to claim 1, wherein said bamboo leaves are biaxially mixed so as to be pulpified.

4. The speaker diaphragm according to claim 1, wherein the fibers extracted from the bamboo leaves are obtained by making the bamboo leaves finer with at least one piece of equipment of a bead mill, a pressure-type homogenizer, and a disk refiner.

5. The speaker diaphragm according to claim 4, wherein the bamboo fibers having been made finer are surface-coated by at least either a spraying method or a suction/deposition paper-making method.

6. The speaker diaphragm according to claim 1, wherein raw rubber is contained.

7. The speaker diaphragm according to claim 1, wherein an isocyanate component is further contained, and the fibers extracted from the bamboo leaves are cross-linked by the isocyanate component.

8. A method for manufacturing a speaker diaphragm, comprising:
a mixing step for mixing bamboo fibers into beaten pulp;
a paper-making step for spreading the mixed material in a shape of a speaker diaphragm; and
a drying step for drying the speaker diaphragm,
wherein in the mixing step, water-dispersible polyisocyanate is further mixed.

9. A speaker, comprising:
a frame, coupled to a magnetic circuit;
a speaker diaphragm according to claim 1, which is coupled to a periphery of the frame; and
a voice coil, coupled to the speaker diaphragm.

10. An electronic equipment, comprising:
a speaker having a frame coupled to the magnetic circuit, a speaker diaphragm according to claim 1 coupled to a periphery of the frame, and a voice coil coupled to the speaker diaphragm; and
an amplifier circuit for audio signals to drive the speaker.

11. A mobile device, comprising:
a speaker, incorporated with the speaker diaphragm according to claim 1;
an amplifier circuit for driving the speaker, and
mobile means.
